(19) United States
(12) Patent Application Publication
(10) Pub. No.: US 2024/0377793 A1
(43) Pub. Date: Nov. 14, 2024

(54) SYSTEMS AND METHODS FOR MODEL ADAPTIVE CONTROL

(71) Applicant: Wells Fargo Bank, N.A., San Francisco, CA (US)

(72) Inventor: Himanshu Baral, Fremont, CA (US)

(21) Appl. No.: 18/315,089

(22) Filed: May 10, 2023

(51) Int. Cl. G05B 13/04; G05B 13/02

(52) U.S. Cl. CPC G05B 13/04; G05B 13/0265

(57) ABSTRACT

Systems, apparatuses, methods, and computer program products are disclosed for adaptive controlling of computing models. An example method includes: obtaining, via communications hardware, a comment associated with a base model of a base model engine; generating, by an adaptive control model of an adaptive control model engine, an adaptive control instruction for the base model based on the comment; and causing, by the adaptive control model engine, the base model to adapt to the comment using the adaptive control instruction such that a base model output of the base model is affected by the adaptive control instruction.

### BACKGROUND

Computing devices may provide various services. Computing devices may also be trained to automatically provide such services without human intervention.

### BRIEF SUMMARY

Improvements in technology have enabled humans to create self-learning computing models (e.g., artificial intelligence and machine learning based computing models such as generative artificial intelligence (GAI), generative adversarial networks (GAN), or the like) that are able to process data and continuously improve without the need of a human. In particular, these self-learning computing models are designed to generate outputs (e.g., inferences, images, prose, financial advice, or the like) using a set of rules (e.g., an algorithm that processes the input data into the output data). This set of rules may be continuously trained and updated to refine the generated output. As a result, these self-learning computing models may adapt and grow using received feedback (e.g., feedback on the output by an admin, comparing the output to historical data, etc.).

However, the adaptiveness of these self-learning computing models is limited in certain situations (e.g., when the input data is lacking, when the set of rules is not configured to process certain types of input data, when disrupted by a human through insertion of a human in the loop element within the artificial intelligence/machine learning model operation loop, etc.). For example, a user may request a self-learning computing model to focus sampling towards a specific category of data within a larger dataset (e.g., data for a specific ethnic group among a plurality of ethnic groups). If the specific category of data includes only a single datapoint within the dataset, a self-learning computing model configured with a set of rules that requires a category of data have a minimum threshold of datapoints (e.g., at least 20) will think that it is not able to process the user's request, and may initiate operations for model retraining and/or redevelopment in order to become capable of processing the user's request. However, such retraining and/or redevelopment (which disadvantageously costs a lot of time, money, and computing resources for entities (e.g., businesses, organizations, or the like) operating these self-learning computing models) may not always be necessary because the self-learning computing model is actually (but is just unaware that is it) able to adapt to the user's request (e.g., through executing one or more pre-processing or post processing techniques on the input or output data, respectively).

To address such lack in adaptiveness of self-learning computing models, example embodiments described herein provide methods and systems for providing improved adaptive control of self-learning computing models (also referred to herein as “model adaptive control”). In particular, an adaptive control self-learning computing model (referred to herein as an “adaptive control model” and will be described in more detail below in connection with FIGS. 3 and 4) may be configured to provide one or more adaptive control instructions to a base self-learning computing model (referred to herein as a “base model” and will be described in more detail below in connection with FIGS. 3 and 4). Such adaptive control instructions may be based on one or more comments (e.g., customer feedback, feedback from a component designed to monitor an output of the base model, feedback and/or instructions from a user of the base model, or the like) made about one or more aspects (e.g., the output, services and/or products offered by an entity based on the output, or the like) of the base model. Such adaptive control instructions may also take into account the capabilities of the base model such that the adaptive control model may cause the base model to adapt to user requests that the base model itself believes it is not capable of handling without model retraining and/or redevelopment. As a result, the base model will be able to better adapt to user requests while unnecessary retraining and/or redevelopment of the base model is effectively reduced, which results in a direct improvement to at least the technical field of artificial intelligence and machine learning.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a device that may perform various operations in accordance with some example embodiments described herein.

FIG. 3 illustrates an example flowchart for providing model adaptive control, in accordance with some example embodiments described herein.

FIG. 4 illustrates an example flowchart for providing model adaptive control, in accordance with some example embodiments described herein

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

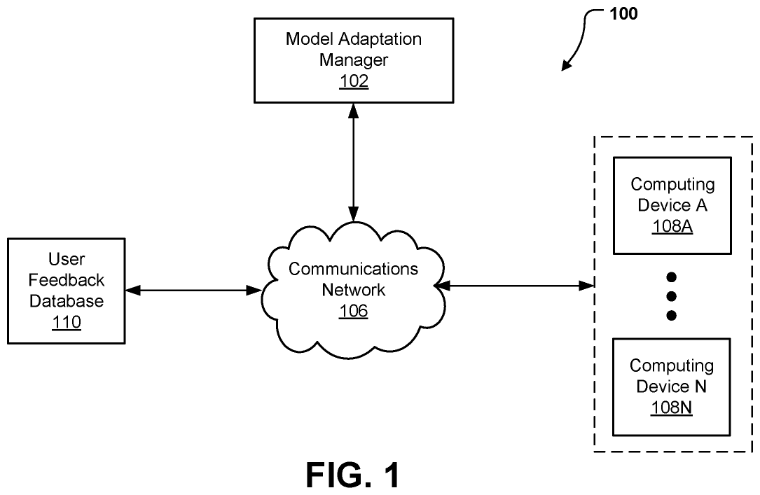

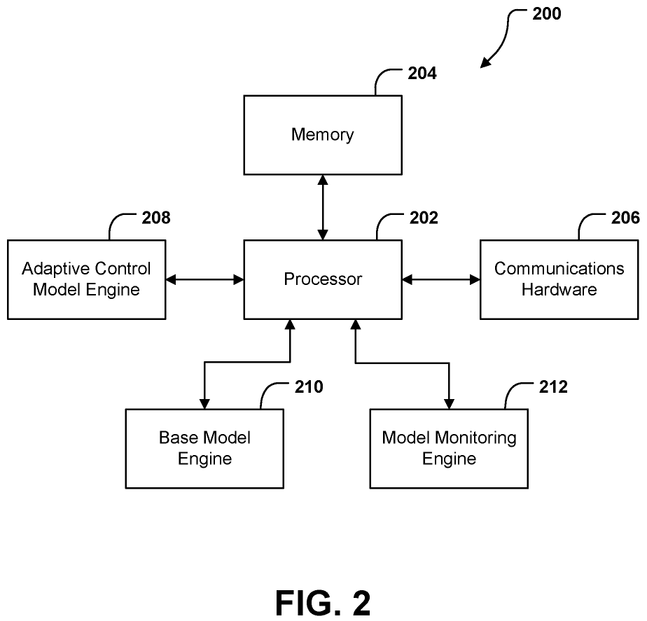

Example embodiments described herein may be implemented using any of a variety of computing devices or servers. To this end, FIG. 1 illustrates an example system 100 within which various embodiments may operate. As illustrated in FIG. 1, the system may include a model adaptation manager 102 that may receive and/or transmit information via communications network 106 (e.g., the Internet) with any number of other devices, such as computing devices 108A-108N and user feedback database 110. In some embodiments, users (e.g., a developer and/or an administrator of one or more self-learning computing models, or the like) may directly interact with the model adaptation manager 102 (e.g., via communications hardware 206 of model adaptation manager 102, which is discussed in more detail below in reference to FIG. 2), in which case a separate computing device connected to the model adaptation manager 102 (e.g., in an instance where the threat manager is a server disposed at a location that is not physically accessible to the users of the server) may not be utilized. Whether by way of direct interaction or via a separate computing device, a user may communicate with, operate, control, modify, or otherwise interact with the model adaptation manager 102 to perform the various functions and achieve the various benefits described herein.

In some embodiments, model adaptation manager 102 may be implemented as one or more computing devices or servers, which may be composed of a series of components. Particular components of the threat manager are described in greater detail below with reference to apparatus 200 in FIG. 2.

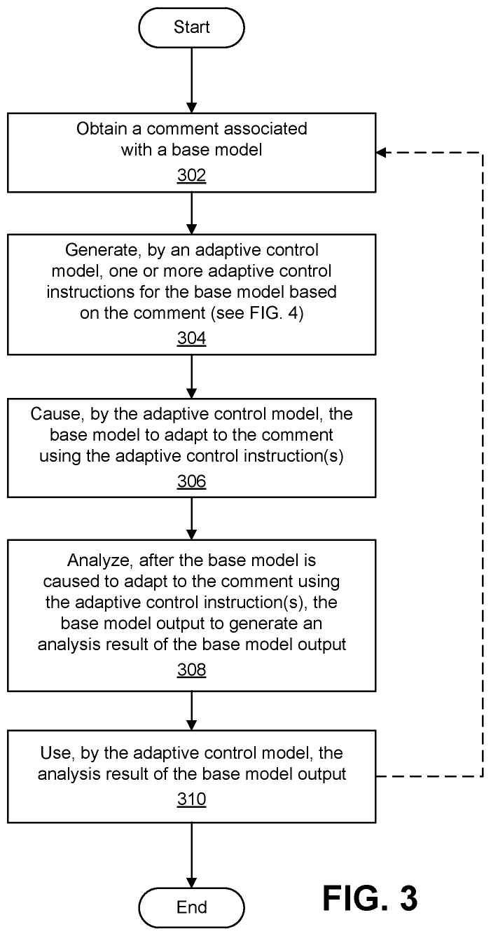

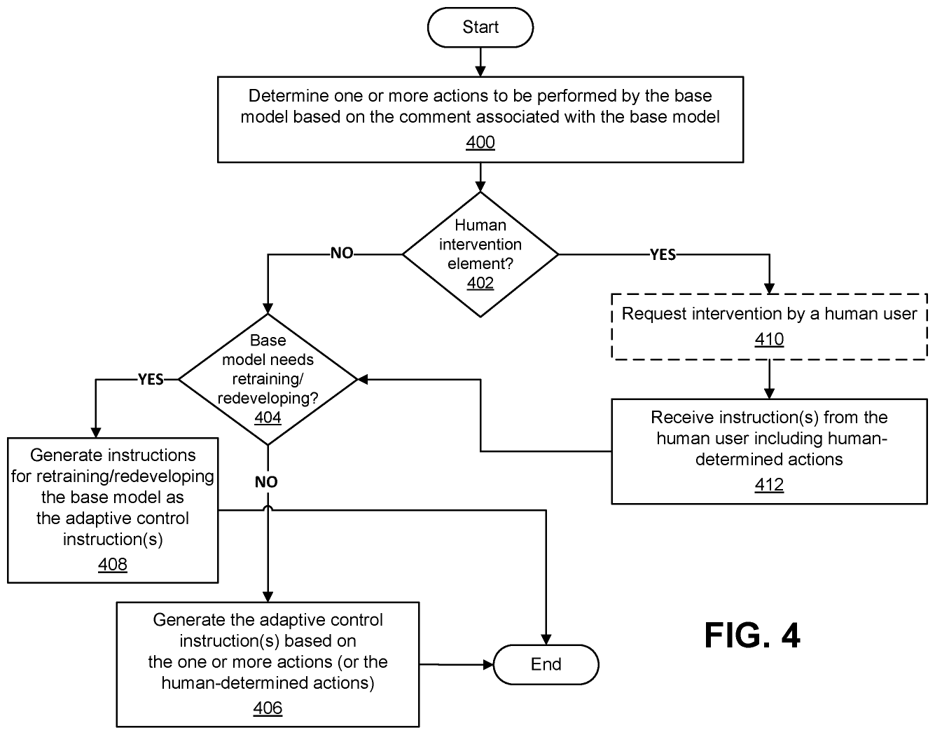

In some embodiments, the computing devices 108A-108N may be embodied by any computing devices known in the art such as desktop or laptop computers, mobile phones (e.g., smart phones), tablets, servers, server devices, or the like. Each of the computing devices 108A-108N need not themselves be independent devices, but may be peripheral devices communicatively coupled to other computing devices. For example, each of the computing devices 108A-108N may be a computing device belonging to an individual (or group) within an entity (e.g., a business, an organization, or the like). As another example, each of the computing devices 108A-108N may be a server provisioned with software enabling the server to provide one or more computing services (e.g., the operations of one or more embodiments discussed in more detail below in reference to the flowcharts of FIGS. 3 and 4).

In some embodiments, the user feedback database 110 may be embodied by any computing devices known in the art (as discussed above). These computing devices may be configured with memory and/or storage (e.g., one or more direct-attached storage (DAS) devices (such as hard drives, solid-state drives, optical disc drives, or the like) or may alternatively comprise one or more Network Attached Storage (NAS) devices independently connected to a communications network (e.g., communications network 106)) storing public data (e.g., data accessible to the public via the Internet) that can be mined (e.g., retrieved) by other computing devices (e.g., model adaptation manager 102) connected to the communications network 106. Although only a single one of the user feedback database 110 is shown in FIG. 1, some embodiments of the system 100 may include multiple ones of the user feedback database 110 (e.g., multiple user feedback databases). In an instance where there are multiple ones of the user feedback database 110, each of the user feedback databases need not themselves be independent devices, but may be peripheral devices communicatively coupled to other computing devices.

### Example Implementing Apparatuses

The model adaptation manager 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3 and 4. As illustrated in FIG. 2, the apparatus 200 may include processor 202, memory 204, communications hardware 206, adaptive control model engine 208, base model engine 210, and model monitoring engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an adaptive control model engine 208 that is configured to operate and host (e.g., perform operations associated with) an adaptive control model. In some embodiments, the adaptive control model may be any type of artificial intelligence and/or machine learning based self-learning model. The adaptive control model engine 208 may utilize processor 202, memory 204, or any other hardware component included in the apparatus 200 to perform operations associated with the adaptive control model, as described in connection with FIGS. 3 and 4 below. The adaptive control model engine 208 may further utilize communications hardware 206 to gather data from a variety of sources (e.g., any of the computing devices 108A-108N and/or the user feedback database 110, as shown in FIG. 1), and/or exchange data with a user, and in some embodiments may utilize processor 202 and/or memory 204 to operate and host the adaptive control model.

In addition, the apparatus 200 further comprises a base model engine 210 that is configured to host (e.g., perform operations associated with) a base model. In some embodiments, the base model may be any type of artificial intelligence and/or machine learning based self-learning model. The base model engine 210 may utilize processor 202, memory 204, or any other hardware component included in the apparatus 200 to perform operations associated with the base model, as described in connection with FIGS. 3 and 4 below. The base model engine 210 may further utilize communications hardware 206 to gather data from a variety of sources (e.g., any of the computing devices 108A-108N and/or the user feedback database 110, as shown in FIG. 1), and/or exchange data with a user, and in some embodiments may utilize processor 202 and/or memory 204 to operate and host the base model.

Further, the apparatus 200 further comprises a model monitoring engine 212 that is configured to monitor and analyze a model output of one or more self-learning computing models (e.g., the adaptive control model and the base model). The model monitoring engine 212 may utilize processor 202, memory 204, or any other hardware component included in the apparatus 200 to perform these operations, as described in connection with FIGS. 3 and 4 below. The model monitoring engine 212 may further utilize communications hardware 206 to gather data from a variety of sources (e.g., any of the computing devices 108A-108N and/or the user feedback database 110, as shown in FIG. 1), and/or exchange data with a user, and in some embodiments may utilize processor 202 and/or memory 204 to monitor and analyze a model output of one or more self-learning computing models. Additional details of the operations of the model monitoring engine (including functionalities and capabilities not currently discussed in this paragraph) are described below in connection with FIGS. 3 and 4.

Although components 202-212 are described in part using functional language, it will be understood that the particular implementations necessarily include the use of particular hardware. It should also be understood that certain of these components 202-212 may include similar or common hardware. For example, the adaptive control model engine 208, base model engine 210, and model monitoring engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the adaptive control model engine 208, base model engine 210, and model monitoring engine 212 may leverage processor 202, memory 204, or communications hardware 206 as described above, it will be understood that any of the adaptive control model engine 208, base model engine 210, and model monitoring engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the adaptive control model engine 208, base model engine 210, and model monitoring engine 212 comprise particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatuses 200, example embodiments are described below in connection with a series of flowcharts.

### Example Operations

Turning to FIG. 3, an example flowchart is illustrated that contains example operations implemented by example embodiments described herein. The operations illustrated in FIG. 3 may, for example, be performed by the model adaptation manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, adaptive control model engine 208, base model engine 210, model monitoring engine 212, and/or any combination thereof. It will be understood that user interaction with the model adaptation manager 102 may occur directly via communications hardware 206, or may instead be facilitated by a separate computing device (not shown in the figures) that may have similar or equivalent physical componentry facilitating such user interaction.

Turning first to FIG. 3, example operations are shown for improving adaptiveness of a self-learning computing model.

As shown by operation 302, the apparatus 200 includes means, such as processor 202, memory 204, communications hardware 206, and adaptive control model engine 208, or the like, for obtaining one or more comments associated with a base model (e.g., a base model hosted by the base model engine 210).

In some embodiments, the comment(s) may be received by communications hardware 206 (e.g., a comment is transmitted from an external source such as any one of the computing devices 108A-108N of FIG. 1, a comment is input by a user of the apparatus 200 using one or more input devices (e.g., mouse, keyboard, or the like) of the communications hardware 206, or the like). The comment(s) may also be retrieved by apparatus 200 (e.g., via use of communications hardware 206) from any external sources (e.g., any of the computing devices 108A-108N and the user feedback database 110 of FIG. 1). Other known ways of obtaining data from a source (e.g., an external computing device, a network drive, a universal serial bus (BUS) device, or the like) external to the apparatus 200 may also be used without departing from the scope of one or more embodiments disclosed herein. Once obtained, the comment is provided (e.g., by communications hardware 206) to the adaptive control model engine 208.

In some embodiments, the comment may be stored in memory 204 of the apparatus 200. The comment may be retrieved from the memory 204 directly by the adaptive control model engine 208. Additionally or alternatively, the comment may be first retrieved by communications hardware 206 or processor 202 and (internally) transmitted using these components of apparatus 200 to the adaptive control model engine 208. In some embodiments, the comment may be received at any time (e.g., in real-time, in near real-time, at an interval specified by the user of the apparatus 200, or the like). Said another way, the apparatus 200 is configured such that the base model (e.g., via the base model engine 210) is able to adapt (as discussed in more detail below) to the comment(s) at any time (e.g., in real-time, in near real-time, at an interval specified by the user of the apparatus 200, or the like).

In some embodiments, the base model hosted by base model engine 210 may be one or more generative adversarial networks (GAN) and/or generative artificial intelligence (GAI) models. For example, in an instance where the entity hosting apparatus 200 is a financial institution, the base model may be configured (e.g., trained and set up with one or more sets of algorithms) to generate financial-related services and/or products (e.g., payment card related promotions and services, new payment card ideas, various types of loans, financial tips, or the like) that can be provided by the financial institution.

In some embodiments, the comment may include information on how a base model (namely, an operation of the base model) should be affected to meet one or more specified needs. For example, the comment may be, but is not limited to: customer feedback, model feedback of the base model generated by model monitoring engine 212 (discussed in more detail below in connection with operation 310 of FIG. 3), instructions from a human user (e.g., an administrator, a developer, or the like) of apparatus 200 (also referred to as “human instruction(s) for affecting one or more operations of the base model”), or the like. The customer feedback and the model feedback of the base model may indicate the needs (e.g., critiques, comments, requests, reactions, or the like) of customers of an entity (e.g., a corporation, a financial institution, or the like) using the apparatus 200 (namely, the base model) to provide one or more products and/or services (e.g., the above-discussed financial-related services and/or products provided by a financial institution). Said another way, the customer feedback and the model feedback of the base model may indicate the needs of the entity's customer based on the customer's reactions to the provided products and/or service. The instructions from the human user of the apparatus 200 may indicate the needs of the human user as to how the human user wants the base model to operate (e.g., a specific task or set of tasks that the human user wants the base model to execute, one or more base model outputs that the human user want the base model to generate, how the human wants the base model to process input data to generate output data, or the like). Other forms of comments that specify the needs of a human (e.g., a customer of an entity operating apparatus 200, a user of apparatus 200, or the like) may be included without departing from the scope of one or more embodiments disclosed herein.

As shown by operation 304, the apparatus 200 includes means, such as processor 202, memory 204, adaptive control model engine 208, or the like, for generating one or more instructions (e.g., using the adaptive control model of the adaptive control model engine 208) (herein also referred to as “adaptive control instructions”) for the base model. In some embodiments, the adaptive control instruction(s) may be generated based on the comments associated with the base model (e.g., the comments obtained in operation 302).

In some embodiments, the adaptive control model hosted by the adaptive control model engine 208 may be, for example, an inference model (or a combination of inference models) that may generate inferences and/or that may be used to recognize patterns, automate tasks, and/or make decisions. In particular, the adaptive control model may, for example, be implemented with artificial neural networks, decision trees, support-vector machines, regression analysis, Bayesian networks, genetic algorithms, and/or any other type of model usable for learning purposes. The type of inference model(s) used as the adaptive control model may depend on the goals of the downstream consumers (e.g., the customers of the entity) and/or other factors such as (i) training dataset characteristics (e.g., data type, size and/or complexity), (ii) cost limitations (e.g., the cost to train and/or maintain the inference model), (iii) time limitations (e.g., the time to train the inference model and/or for inference generation), and/or (iv) inference characteristics (e.g., accuracy and/or inference type). For example, a complex inference model such as a muti-layered neural network may process a large amount of complex data and generate highly accurate inferences, but may be costly to train and maintain and may have low explainability (e.g., may act as a “black box”). In contrast, a linear regression model may be a simpler, less costly inference model with high explainability, but may only be well-suited for data whose labels are linearly correlated with the selected features and may generate less accurate inferences than a neural network.

In some embodiments, the adaptive control model may be configured to control the base model in a manner that causes the base model to adapt to the comments associated with the base model. As an analogy, assume that the adaptive control model is the cruise control terminal (e.g., cruise control device) of a motor vehicle and that the comments are instructions (e.g., setting a new speed, changing a vehicle distance threshold, or the like) provided by a driver of the motor vehicle to the cruise control terminal. The adaptive control model may take the comments and generate (e.g., as an output of the adaptive control model) one or more instructions (e.g., based on training data used to train the adaptive control model including a set of predefined and/or pre-mapped rules, information on the base model such as the operating specification and parameters of the base model, or the like) to be implemented by the base model such that the base model is able to adapt to the obtained comment(s).

To better understand how the adaptive control model generates the adaptive control instruction(s) for the base model based on the comment(s), we now turn to the flowchart of FIG. 4 that shows the operations for generating the adaptive control instruction(s). In particular, FIG. 4 shows an example flowchart that contains example operations implemented by example embodiments described herein. The operations illustrated in FIG. 4 may, for example, be performed by the model adaptation manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, adaptive control model engine 208, base model engine 210, model monitoring engine 212, and/or any combination thereof. It will be understood that user interaction with the model adaptation manager 102 may occur directly via communications hardware 206, or may instead be facilitated by a separate computing device (not shown in the figures) that may have similar or equivalent physical componentry facilitating such user interaction.

Starting with operation 400 of FIG. 4, as shown by operation 400, the apparatus 200 includes means, such as processor 202, memory 204, adaptive control model engine 208, or the like, for determining one or more actions to be performed by the base model based on the comment associated with the base model (e.g., the comment(s) obtained in operation 302 of FIG. 3). In some embodiments, the action(s) determined by the adaptive control model may be included in (e.g., compiled into) the adaptive control instruction(s) generated by the adaptive control model.

In some embodiments, the adaptive control instruction(s) generated by the adaptive control instruction may be one or more inferences generated by the adaptive control model using: (i) input data including the comment(s); and (ii) training data including one or more sets of predefined and/or pre-mapped rules, information on the base model such as the operating specification and parameters of the base model that indicate the capabilities of the base model (e.g., what the base model is or is not able to do), or the like. Said another way, the adaptive control model is trained using the training data to generate the action(s) based on the comment(s) provided as the input. For example, assume that a comment indicates that a specific ethnic group within a dataset being used by the base model as input to generate the base model output should be given more priority than the other ethnic groups covered within the dataset. Further assume that the training data of the adaptive control model indicates that such type of comments where particular data should be given more priority are best resolved by adjusting the weights assigned to data by the base model while the base model is processing (e.g., ingesting) the dataset as input data. In this example, the action(s) determined by the adaptive control model would be something along the lines of: changing how the base model assigns weight to certain data (e.g., the data associated with the particular ethnic group) when using input data to generate the base model output. Going back to the motor vehicle cruise control analogy, the adaptive control model may be trained (similar to the cruise control device) to determine that a comment requesting more speed is associated with an action of increasing the vehicle speed.

In some embodiments, the one or more action(s) determined by the adaptive control model may include actions to be executed by the base model engine 210 such as: (i) actions related to a pre-processing of the data to be ingested by the base model (e.g., the input data to be ingested by the base model); (ii) actions related to adjustments to one or more parameters within the algorithm (or set of algorithms) used by the base model to generate the base model output using the input data; and/or (iii) actions related to a post-processing of the base model output.

In some embodiments, actions related to the pre-processing of the input data may include: up/down sampling of data classes, reduction of bias in the input data, focusing on one or more segments in the input data, or the like. Other known techniques for pre-processing input data to be ingested into a self-learning computing model may also be used without departing from the scope of one or more embodiments disclosed herein.

In some embodiments, actions related to adjustments to one or more parameters within the algorithm (or set of algorithms) used by the base model to generate the base model output using the input data may include: a reassignment of weights, changes to certain hyperparameters used by the model, or the like. In some embodiments, these adjustments may be adjustments that do not require a retraining of the base model itself (e.g., does not require any reconfiguration and/or editing of the training data used to train the base model, does not require the base model to be trained using any additional training data, or the like). Said another way, these adjustments may be temporary adjustments made to the algorithm (or set of algorithms) used by the base model that can be easily reverted. For example, a current instance of the algorithm (or set of algorithms) used by the base model to generate the base model output may be saved by the base model engine 210 (e.g., stored in memory 204). The adjustments may then be made to the algorithm (or set of algorithms) and the base model may generate the output using the adjusted algorithm (or set of algorithms) as part of the adaptation to the comment. Once the base model output is generated, the base model engine 210 reverts the base model back to the pre-adjusted instance using configuration data of the pre-configured instance stored in memory 204. Other version control techniques/methods may also be used to revert the base model back to a pre-adjusted instance without departing from the scope of one or more embodiments disclosed herein.

In some embodiments, actions related to the post-processing of the base model output may include any known techniques for post-processing of data generated by a self-learning computing model. The post-processing of the base model output may be conducted such that the base model output is adapted to the comments associated with the base model.

As shown by operation 402, the apparatus 200 includes means, such as processor 202, memory 204, adaptive control model engine 208, or the like, for determining whether there is a human intervention element (e.g., an intervention by a user of the apparatus 200) during the determination of the action(s) by the adaptive control model in operation 400.

In some embodiments, some or all of the human intervention element may not be necessitated (e.g., initiated) by the adaptive control model (e.g., via the adaptive control model engine 208). For example, the user of the apparatus 200 may input a command at any time after seeing the obtained comment(s) to override (e.g., circumvent) any actions taken by the adaptive control model during the generation of the action. For example, the user of the apparatus 200 may directly provide the adaptive control model engine 208 with the action(s) to be included in the adaptive control instruction(s) without first waiting for the adaptive control model to determine (e.g., generate) any actions. As another example, the adaptive control model engine 208 may be configured to display (e.g., via a display device connected to apparatus 200) all actions generated by the adaptive control model to the user (e.g., displayed as potential actions for the base model to execute). The user may then have time (e.g., a pre-set amount of time) to intervene and tell the adaptive control model engine 208 to take other actions if the user determines that none of the actions generated by the adaptive control model is acceptable (e.g., suitable) for the user (e.g., based on additional information that the user has that the adaptive control model does not have in its training data). More specifically, in this example, the adaptive control model engine 208 may receive (e.g., via communications hardware 206) a human intervention message comprising one or more action(s) (e.g., action(s) different from any of the actions generated by the adaptive control model) for replacing the actions generated by the adaptive control model.

Additionally or alternatively, in some embodiments, some or all of the human intervention element may be necessitated (e.g., initiated) by the adaptive control model (e.g., via the adaptive control model engine 208). For example, if the adaptive control model determines that it is unable to generate an acceptable action (e.g., based on one or more preset satisfaction thresholds used in the training of the adaptive control model) or unable to generate any actions at all based on how the adaptive control model is trained. As a result, in this example, the adaptive control model will actively seek help (e.g., intervention) from a user by (e.g., via the adaptive control model engine 208) generating a notification to the user indicating that user help (e.g., intervention) is required to determine (e.g., generate) the action(s) to be included in the adaptive control instruction(s). In response, the adaptive control model engine 208 may receive the above-discussed human intervention message from the user. In this instance, the human intervention message may include either: (i) a message indicating that the action(s) determined by the adaptive control model are acceptable; or (ii) one or more different actions to be used instead of the action(s) determined by the adaptive control model.

In some embodiments, in an instance where the human intervention is detected in operation 402 (e.g., YES in operation 402), as shown by operation 402, the apparatus 200 includes means, such as processor 202, memory 204, adaptive control model engine 208, or the like, for requesting intervention by a human user. In particular, as discussed above, some or all of the human intervention element may be necessitated (e.g., initiated) by the adaptive control model (e.g., via the adaptive control model engine 208). For example, if the adaptive control model determines that it is unable to generate an acceptable action (e.g., based on one or more preset satisfaction thresholds used in the training of the adaptive control model) or unable to generate any actions at all based on how the adaptive control model is trained. As a result, in this example, the adaptive control model will actively seek help (e.g., intervention) from a user by (e.g., via the adaptive control model engine 208) generating a notification to the user indicating that user help (e.g., intervention) is required to determine (e.g., generate) the action(s) to be included in the adaptive control instruction(s).

As shown by operation 412, the apparatus 200 includes means, such as processor 202, memory 204, adaptive control model engine 208, or the like, for receiving one or more instructions from the human user (also referred to herein as “human-determined actions”). In some embodiments, as discussed above as part of the human intervention element, the adaptive control model engine 208 may receive (e.g., via communications hardware 206) the human intervention message comprising one or more action(s) (e.g., action(s) different from any of the actions generated by the adaptive control model) for replacing the actions generated by the adaptive control model. Alternatively, the human intervention message may indicate that the action(s) determined by the adaptive control model are acceptable (e.g., the action(s) determined by the adaptive control model now become (e.g., are used as) the human-determined actions). Upon receipt of the human intervention message, the process of FIG. 4 may move to operation 404 (as discussed in more detail below).

In some embodiments, in an instance where the human intervention is not detected in operation 402 (e.g., NO in operation 402), the process of FIG. 4 may proceed to operation 404. In particular, as shown by operation 404, the apparatus 200 includes means, such as processor 202, memory 204, adaptive control model engine 208, or the like, for determining whether the base model needs retraining and/or redeveloping. More specifically, whether the base model needs retraining and/or redeveloping to be able to execute the action(s) to be included as the adaptive control instruction(s) (e.g., to be capable of executing the adaptive control instruction(s)).

In some embodiments, the determination in operation 404 may be conducted by the adaptive control model engine 208 using the training data used to the train the adaptive control model. More specifically, the training data associated with the information on the base model such as the operating specification and parameters of the base model that indicate the capabilities of the base model (e.g., what the base model is or is not able to do). In some embodiments, the adaptive control model engine 208 may also communicate with the base model engine 210 at any time (e.g., in real-time, in near real-time, at an interval specified by the user of the apparatus 200, or the like) to retrieve such information on the base model and supplement the retrieved information with existing information included in the training data in order to keep a most-up-to-date knowledge (e.g., keep a most-up-to-date set of training data) of the functions and capabilities of the base model.

In some embodiments, if the adaptive control model engine 208 determines that it is unable to make an accurate determination of whether the base model requires retraining and/or redeveloping (e.g., if the adaptive control model engine 208 generates an inference based on the functions and capabilities of the base model that fall below a predetermined accuracy threshold set by a user), the adaptive control model engine 208 may again request for intervention by the human user (e.g., similar to operation 410) to make the final determination (e.g., to make the executive decision as to whether the base model needs to be retrained and/or redeveloped.

In some embodiments, in the event that the adaptive control model engine 208 (e.g., by itself or through intervention by the human user) determines in operation 404 that the base model does not need retraining and/or redeveloping (e.g., NO in operation 404), the process of FIG. 4 proceeds to operation 406. In particular, as shown by operation 406, the apparatus 200 includes means, such as processor 202, memory 204, adaptive control model engine 208, or the like, for generating the adaptive control instruction(s) based on the one or more actions (e.g., the one or more actions determined in operation 400) or the human-determined action(s) (e.g., in the event that a human intervention element existed in operation 402 such that the one or more instructions determined in operation 400 were replaced with the human-determined actions received in operation 412).

Alternatively, in some embodiments, in the event that the adaptive control model engine 208 (e.g., by itself or through intervention by the human user) determines in operation 404 that the base model does need retraining and/or redeveloping (e.g., YES in operation 404), the process of FIG. 4 proceeds instead to operation 408. In particular, as shown by operation 408, the apparatus 200 includes means, such as processor 202, memory 204, adaptive control model engine 208, or the like, for generating the retraining and/or redeveloping instructions as the adaptive control instructions. How the base model (e.g., via the base model engine 210) uses such instructions indicating that the base model should be retrained and/or redeveloped will be discussed in more detail below in reference to operation 308 of FIG. 3.

Turning back now to the flowchart of FIG. 3, as shown by operation 306, the apparatus 200 includes means, such as processor 202, memory 204, adaptive control model engine 208, base model engine 210, or the like, for causing the base model to adapt to the comment using the adaptive control instruction(s).

In some embodiments, causing the base model to adapt to the comment using the adaptive control instruction(s) may depend on the action(s) (e.g., the pre-processing, algorithm adjusting, and/or post-processing actions discussed above) included in the adaptive control instruction(s). In some embodiments, the adaptive control model engine 208 may provide (e.g., transmit) the adaptive control instruction(s) to the base model engine 210. The base model engine 210 may then perform the adaptive control instruction(s) directly or cause (e.g., instruct) the base model to execute the adaptive control instruction(s). For example, in an instance where the adaptive control instruction(s) include only the pre-processing and/or post-processing actions, the base model engine 210 may then perform the adaptive control instruction(s) directly. In a different instance where the adaptive control instruction(s) include actions directed to algorithm adjustments, the base model engine 210 may cause the base model to generate the base model output after the base model applies the algorithm adjustments (while also implementing the version control process(es)).

In some embodiments, in instances where the adaptive control instruction(s) include the pre-processing and/or algorithm adjusting action(s), the base model output of the base model is affected through execution of these actions by the base model (e.g., the base model output is generated based on the execution of these actions by the base model. In some embodiments, in instances where the adaptive control instructions include the post-processing action(s), the base model output is affected by the adaptive control instruction(s) through post-processing of the base model output by the base model engine 210 (e.g., the base model output is changed by the base model engine 210 to adapt the base model output to the comments associated with the base model).

As shown in operation 308, the apparatus 200 includes means, such as processor 202, memory 204, model monitoring engine 212, or the like, for analyzing and/or monitoring the base model output. In some embodiments, the base model output may be analyzed and/or monitored by the model monitoring engine 212 after the base model is caused to adapt to the comment using the adaptive control instruction(s).

In some embodiments, the model monitoring engine 212 may be configured with one or more rules and/or requirements (e.g., based on one or more key performance indexes (KPIs), or the like). The model monitoring engine 212 may determine (e.g., using the one or more rules and/or requirements and at any time interval set by a user of the apparatus 200) whether the base model output is satisfactory to the user of the apparatus 200. For example, assume that the entity associated with the apparatus 200 is a financial institution and that the base model output is a payment card promotion event that is rolled out (e.g., provided) by the financial institution to the financial institution's customers. The model monitoring engine 212 may be configured to analyze and/or monitor a result of the payment card promotion (e.g., at predetermined intervals set by the financial institution) to determine whether the payment card promotion is successful (e.g., through monitoring of the number of customers (new or old) that signed up for the payment card promotion and comparing such data with predetermined success milestones set by the financial institution). As another example using the financial institution as the user of the apparatus 200, the base model output may be a payment card promotion proposal. The payment card promotion proposal may include estimated data (e.g., projection data) on how well the promotion may be received if the promotion is rolled out (e.g., offered) by the financial institution to a group of customers (e.g., the general public, existing customers, or the like). Before the payment card promotion proposal is actually rolled out as a payment card promotion, the model monitoring engine 212 may analyze the projected data to determine whether the projected data meets the predetermined rules and/or requirements set by the financial institution for conversion of a proposal to an actual promotion.

In some embodiments, a result of the analyzing and/or monitoring of the model monitoring engine 212 (herein referred to as an “analysis result of the base model output”) may be provided by the monitoring engine 212 to the adaptive control model engine 208. This analysis result of the base model output may include the above-discussed model feedback of the base model generated by model monitoring engine 212. The model feedback may indicate whether the base model output meets the one or more rules and/or requirements set by the user including information indicating what the base model output includes that is satisfactory and what the base model is lacking. Said another way, this model feedback may be provided such that the adaptive control model may cause the base model to adapt to the evaluation of the base model output by the model monitoring engine 212. Turning back to the example using the financial institution rolling out a payment card promotion, the results of the promotion (e.g., ground truth data) recorded by the model monitoring engine 212 may be used by the adaptive control model to adapt the base model to a success or failure of the payment card promotion.

As shown in operation 308, the apparatus 200 includes means, such as processor 202, memory 204, adaptive control model engine 208, base model engine 210, model monitoring engine 212, or the like, for using the analysis result of the base model output (e.g., by the adaptive control model).

In some embodiments, in an instance where the adaptive control model determines using the analysis result (e.g., a positive result indicating the base model output is satisfactory) that the base model is operating in a satisfactory manner, the adaptive control model may: (i) store the results (e.g., in memory 204) for future reference (and/or use the results for further training of the adaptive control model; and (ii) take no further action on the initial obtained comment(s) that resulted in the base model output while moving on to newly (e.g., subsequently) received/obtained comments (e.g., return to operation 302 of FIG. 3 to repeat the process using the newly received comment(s)).

In some embodiments, in an instance where the adaptive control model determines using the analysis result (e.g., a positive result indicating the base model output is satisfactory) that the base model is not operating in a satisfactory manner, the adaptive control model may: (i) store the results (e.g., in memory 204) for future reference (and/or use the results for further training of the adaptive control model; and (ii) use the analysis result as the new comment and repeat the process of FIG. 3 until the base model is operating in a satisfactory manner before moving onto a newly (e.g., subsequently) received/obtained comment that may or may not be related to the initial comment obtained in the first iteration of operation 302.

FIGS. 3 and 4 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable improved use and adaptiveness of self-learning computing models. For example, including an adaptive control model to control another self-learning computing model, an adaptive system similar to a motor vehicle's cruise control system may be achieved in a self-learning computing model environment. Said another way, one model may be configured (e.g., controlled) to adapt (e.g., in real-time, near real-time, or at any preset time interval) to a user's desired use of that model. As discussed above in reference to FIGS. 3-4, because the controlling model is able to determine whether the controlled model has the functionalities and capabilities to be adapted to the user's desired use, complete retraining and/or redevelopment of the controlled model can be reduced to adapt the controlled model to the user's desired use. As a result, the controlled model (e.g., the base model) will be able to better adapt to the needs of the user while unnecessary retraining and/or redevelopment of the base model is effectively reduced, which results in a direct improvement to the technical field of artificial intelligence and machine learning.

As these examples all illustrate, example embodiments contemplated herein provide technical solutions that solve real-world problems faced during normal providing of services using self-learning computing models (e.g., automatic chats and/or calls using chatbots, automatic generation of products and/or services using artificial intelligence (AI), or the like). In particular, feedback on the outputs generated by self-learning computing models is rich in information for improving these models, and the ability to easily and quickly adapt to such feedback advantageously allows such models to meet the ever-growing demand from customers of services and/or products offered by such self-learning computing models.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
obtaining, via communications hardware, a comment associated with a base model of a base model engine;
generating, by an adaptive control model of an adaptive control model engine, an adaptive control instruction for the base model based on the comment; and
causing, by the adaptive control model engine, the base model to adapt to the comment using the adaptive control instruction such that a base model output of the base model is affected by the adaptive control instruction.

2. The method of claim 1, further comprising:
receiving, by the adaptive control model engine and from a model monitoring engine, an analysis result of the base model output; and
causing, by the adaptive control model engine, generation of a second adaptive control instruction for the base model based on the analysis result of the base model output.

3. The method of claim 1, wherein generating the adaptive control instruction for the base model further comprises:
determining, by the adaptive control model and based on the comment associated with the base model, an action to be performed by the base model; and
including, by the adaptive control model and when generating the adaptive control instruction, the action in the adaptive control instruction.

4. The method of claim 3, wherein determining the action to be performed by the base model further comprises:
determining, by the adaptive control model, that human intervention is required to determine the action;
generating, by the adaptive control model, a request for human intervention to determine the action; and
receiving, based on the request and from a result of the human intervention, the action to be used to generate the adaptive control instruction.

5. The method of claim 3, wherein:
determining the action to be performed by the base model further comprises:
displaying, by the adaptive control model engine, a potential action on a display,
receiving, via the communications hardware and in response to displaying the action, a human intervention message comprising a different action from the potential action, and
replacing, by the adaptive control model engine, the potential action with the different action; and
generating the adaptive control instruction based on the action further comprises:
generating, by the adaptive control model and based on the replacing of the action with the different action, the adaptive control instruction to include the different action instead of the potential action.

6. The method of claim 3, wherein generating the adaptive control instruction based on the action further comprises:
determining, by the adaptive control model, that the base model requires retraining or redeveloping to be capable of executing the adaptive control instruction; and
replacing, by the adaptive control model and based on determining that the base model requires retraining, the adaptive control instruction with an instruction for retraining or developing the base model.

7. The method of claim 3, wherein generating the adaptive control instruction based on the action further comprises:
determining, by the adaptive control model, that the base model is capable of executing the adaptive control instruction; and
generating, by the adaptive control model and based on determining that the base model is capable of executing the adaptive control instruction, the adaptive control instruction based on the action.

8. The method of claim 7, wherein the action comprises, by the base model engine, a pre-processing of data to be ingested by the base model.

9. The method of claim 7, wherein the action comprises a post-processing of the base model output by the base model engine.

10. The method of claim 1, wherein the comment comprises at least one of customer feedback, model feedback of the base model generated by a model monitoring engine, or a human instruction for affecting one or more operations of the base model.

11. An apparatus comprising:
communications hardware configured to obtain a comment associated with a base model of a base model engine;
an adaptive control model engine configured to:
generate, using an adaptive control model hosted by the adaptive control model engine, an adaptive control instruction for the base model based on the comment, and
cause the base model to adapt to the comment using the adaptive control instruction such that a base model output of the base model is affected by the adaptive control instruction.

12. The apparatus of claim 11, wherein the adaptive control model engine is further configured to:
receive, from a model monitoring engine, an analysis result of the base model output; and
cause generation of, using the adaptive control model, a second adaptive control instruction for the base model based on the analysis result of the base model output.

13. The apparatus of claim 11, wherein as part of generating the adaptive control instruction for the base model, the adaptive control model engine is further configured to:
determine, using the adaptive control model and based on the comment associated with the base model, an action to be performed by the base model; and
include, using the adaptive control model and when generating the adaptive control instruction, the action in the adaptive control instruction.

14. The apparatus of claim 13, wherein as part of determining the action to be performed by the base model, the adaptive control model is further configured to:
determine, using the adaptive control model, that human intervention is required to determine the action;
generate, using the adaptive control model, a request for human intervention to determine the action; and
receive, based on the request and from a result of the human intervention, the action to be used to generate the adaptive control instruction.

15. The apparatus of claim 11, wherein the comment comprises at least one of customer feedback, model feedback of the base model generated by a model monitoring engine, or a human instruction for affecting one or more operations of the base model.

16. A computer program product comprising at least one non-transitory computer-readable storage medium storing software instructions that, when executed, cause an apparatus to:
obtain a comment associated with a base model of a base model engine;
generate, using an adaptive control model hosted by an adaptive control model engine of the apparatus, an adaptive control instruction for the base model based on the comment; and
cause the base model to adapt to the comment using the adaptive control instruction such that a base model output of the base model is affected by the adaptive control instruction.

17. The computer program product of claim 16, wherein the apparatus is further caused to:
receive, from a model monitoring engine, an analysis result of the base model output; and
cause generation of, using the adaptive control model, a second adaptive control instruction for the base model based on the analysis result of the base model output.

18. The computer program product of claim 16, wherein generating the adaptive control instruction for the base model further comprises causing the apparatus to:
determine, based on the comment associated with the base model, an action to be performed by the base model; and
include, when generating the adaptive control instruction, the action in the adaptive control instruction.

19. The computer program product of claim 18, wherein determining the action to be performed by the base model further comprises causing the apparatus to:
determine, using the adaptive control model, that human intervention is required to determine the action;
generate, using the adaptive control model, a request for human intervention to determine the action; and
receive, based on the request and from a result of the human intervention, the action to be used to generate the adaptive control instruction.

20. The computer program product of claim 16, wherein the comment comprises at least one of customer feedback, model feedback of the base model generated by a model monitoring engine, or a human instruction for affecting one or more operations of the base model.
